(19) United States
(12) Patent Application Publication
(10) Pub. No.: US 2010/0006626 A1
(43) Pub. Date: Jan. 14, 2010

(54) Method for Making a Hollow Core Floor and Deck Element

(76) Inventor: Carl R. Marschke, Phillips, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/550,996

(22) Filed: Aug. 31, 2009

Related U.S. Application Data
(62) Division of application No. 11/485,823, filed on Jul. 13, 2006, now abandoned.

(51) Int. Cl. B23K 28/02

(52) U.S. Cl. 228/170

(57) ABSTRACT

A composite structural support which may be utilized as a beam or assembled with similar supports to form a building floor or a bridge deck utilizes an open core element, made preferably of suitably treated fluted paper, upper and lower thin steel skins, and a layer of concrete poured over the top skin. Modules comprising the hollow core element and the upper and lower steel skins are fabricated to lengths required for building floor and bridge spans and, when joined by welding the upper and lower skins of adjacent elements along their full lengths, provide a floor or deck structure of a large span. The open core paper elements may be alternately fabricated from single face corrugated webs or open face double wall webs that are slit to form narrow equal width strips stacked and glued face-to-face.

### CROSS REFERENCE TO RELATED APPLICATIONS

This is a divisional of U.S. application Ser. No. 11/485,823, filed Jul. 12, 2006.

### BACKGROUND OF THE INVENTION

The present invention pertains to a lightweight hollow core structural building element which can be used as a beam or can be joined with other elements to form a floor or deck panel.

The potential for the use of hollow core elements in the construction of buildings and other structures has been known for many years. Hollow cores of corrugated or honeycomb paper or metal sheet material, enclosed by upper and lower skin panels or sheets, have long been used or proposed for use as floor, wall and roof panels for buildings. However, the use of such hollow core panels has been inhibited because of difficulties in fabricating the panels in an efficient and cost effective manner.

In my co-pending patent application Ser. No. 11/476,474, entitled “Method and Apparatus for Manufacturing Open Core Elements from Web Material”, filed Jun. 28, 2006, now U.S. Pat. No. 7,459,049, which application is incorporated by reference herein, there is disclosed a system for manufacturing hollow core panels of widely varying dimensions using corrugating techniques and a unique lay-up process.

### SUMMARY OF THE INVENTION

In accordance with the present invention, a structural support, such as a floor or bridge deck, is fabricated from open core elements faced with upper and lower steel skins which are welded together and over which a layer of concrete is poured. The present invention is directed particularly to the method of making the structural panels, including use of method steps from my above-identified US patent application.

In one aspect of the invention, a horizontal structural support includes an open core element that has a plurality of corrugated strips of a web material bonded together and having the flutes oriented vertically. The open core element defines horizontal upper and lower surfaces to which steel skins are attached. In accordance with the presently preferred method of the present invention, a load bearing deck is made by the method comprising the steps of (1) forming an open face double wall web comprising two single face webs joined to define an exposed liner web and an exposed fluted web, (2) orienting the double wall web with the exposed fluted web flutes facing up, (3) slitting the open face double wall web longitudinally to form a plurality of adjacent equal width open face double wall strips, (4) gluing the exposed flute tips of each open face double wall strip to the smooth web of a next adjacent strip to form an open core element with the flutes extending between and perpendicular to parallel opposite core element faces, (5) bonding rectangular steel skin sheets to the opposite faces of the core element to form a deck module, and (6) connecting adjacent modules by welding adjacent upper and lower skin sheet edges along abutting long edges of the skin sheets.

A layer of concrete is placed on the upper steel skin. Preferably, the structural support includes a plurality of upstanding steel projections that are attached to the upper steel skin and are embedded in the concrete layer.

In another embodiment, load bearing deck panels are made by a method comprising the steps of (1) forming a single face web comprising a liner web and a fluted web, (2) orienting the single face web with the exposed fluted web flutes facing up, (3) slitting the single face web longitudinally to form a plurality of adjacent equal width single face strips, (4) gluing the exposed flute tips of each single face strip to the smooth web of a next adjacent strip to form an open core element with the flutes extending between and perpendicular to parallel opposite core element faces, (5) bonding rectangular skin sheets to the opposite faces of the core element to form a deck modular, and (6) connecting adjacent modules by welding adjacent upper and lower skin edges along abutting long edges of the skin sheets. A layer of concrete is placed over the entire deck. Close-out panels are placed to enclose portions of the assembled core elements that define the outer periphery of the deck. In a presently preferred construction, the web material for making the open core elements is paper and, most preferably, resin-impregnated paper.

The invention also includes a method for making a load bearing deck or the like comprising the steps of: forming an open core element from a plurality of long and relatively narrow strips of a corrugated web material by bonding the strips together with the flutes extending between the long edges of the strips, and with the open core element defining parallel rectangular upper and lower surfaces perpendicular to the flutes; bonding rectangular steel skins to the upper and lower surfaces of the core element to form a deck module, the skins each having opposite long edges that correspond to the length of the strips; and, connecting adjacent modules by welding together the long edges of adjacent upper skins and lower skins. The method further includes the step of pouring a layer of concrete over the interconnected upper skins to form the deck. The method preferably includes, prior to the concrete pouring step, the step of attaching a plurality of upstanding steel projections to the exposed surfaces of the upper skins, and the pouring step includes embedding the projections in the concrete. Also prior to the pouring step, the method may include the step of placing utility connections on the exposed surface of the upper skins and embedding the connections in the concrete during the pouring step.

### BRIEF DESCRIPTION OF THE DRAWINGS

FIG. 1 is a perspective view of a structural deck or floor assembled from modules according to the present invention;

FIG. 2 is a perspective view, similar to FIG. 1, showing a single open core module used in fabricating the deck of FIG. 1;

FIG. 3 is a sectional view through a single face corrugated web useful in making the hollow open core elements used in the method of the present invention;

FIG. 4 is a sectional view, similar to FIG. 3, showing an open face double wall web that is also useful in an alternate method of forming the hollow core elements used in the method of the present invention; and

FIG. 5 is a sectional view of an open core element made utilizing the webs of FIG. 3 or FIG. 4.

### DETAILED DESCRIPTION OF THE INVENTION

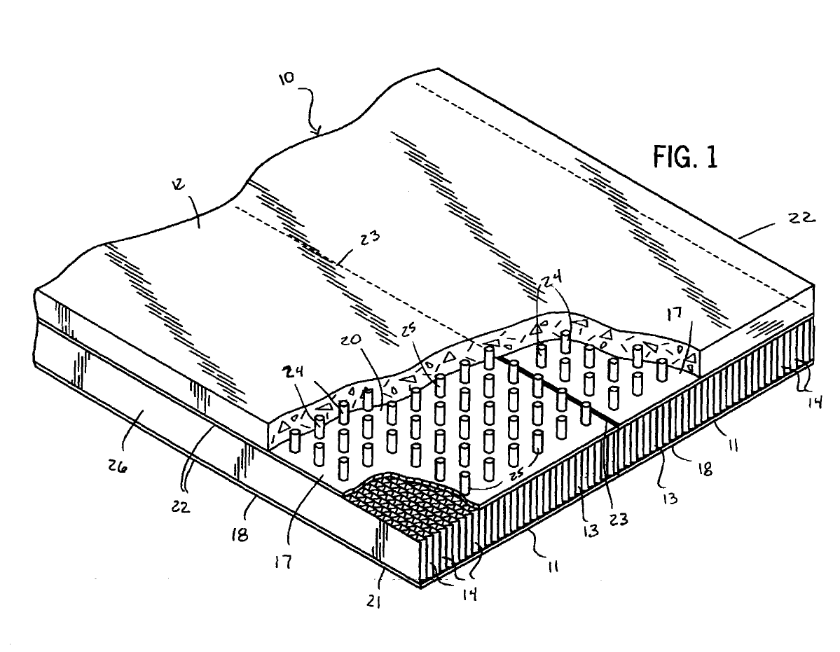

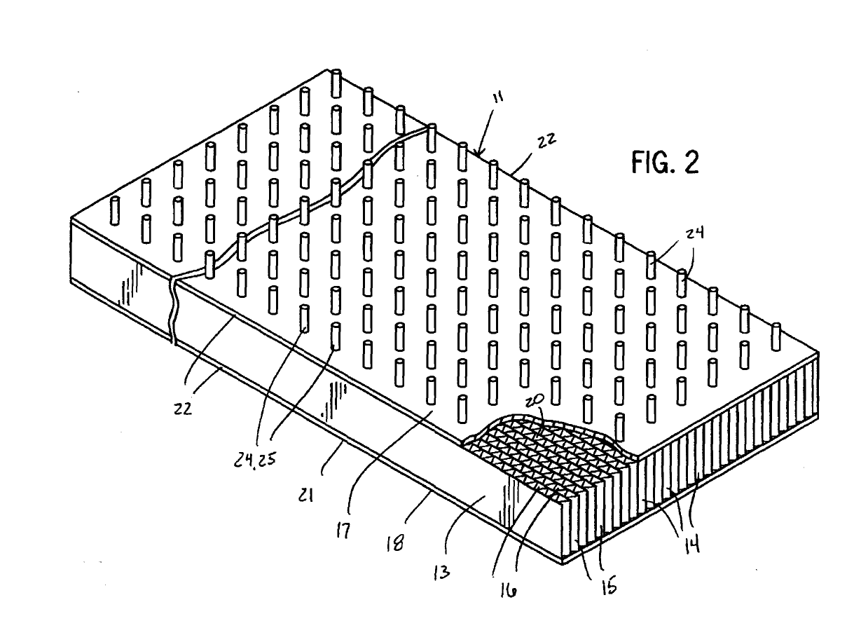

Referring first to FIG. 1, there is shown a portion of a deck 10 or floor useful, for example, in the construction of a bridge or a building, in which a series of long and relatively narrow modules 11 are joined together and covered with a poured concrete slab 12. Each of the modules 11 could be made of any desired dimensions, but for use in a floor deck, for example, module 11 could have a depth or thickness of 16 in., a width of 8 ft. and a length of 50 ft. To fabricate a deck 10 50 ft. long and 64 ft. wide, eight modules 11 would be joined along their long edges, as partly shown in FIG. 1.

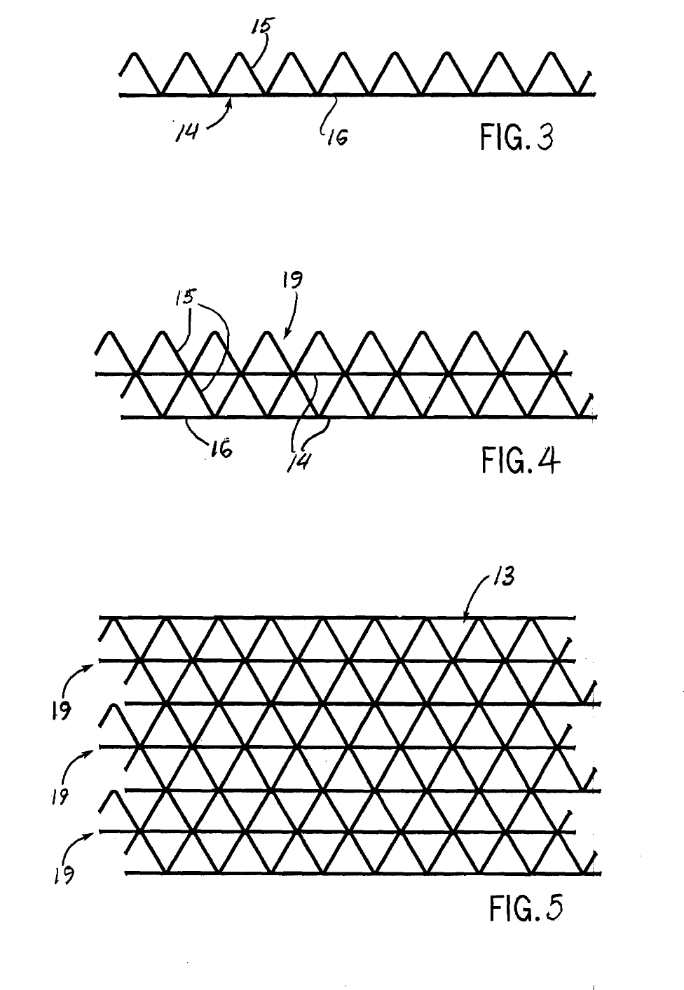

Each deck module 11 includes a hollow core element 13 of the type described and manufactured in accordance with the method disclosed in my above identified patent application. The hollow core element 13 includes a stack of long, narrow corrugated paperboard strips 14, each of which in the embodiment shown comprises a fluted web 15 and a smooth web 16 joined with a suitable adhesive. The webs 15 and 16 may be made of many suitable materials, but resin-impregnated paper is presently preferred. The webs 15 and 16 may be formed from either single face corrugated paperboard strips 14 of FIG. 3 or open face double wall strips 19 of FIG. 4, depending on the rigidity required of the strips in the fabrication of the hollow core element 13. In either event, the single face web or the double wall web are oriented with the exposed fluted web flutes 15 facing upwardly and the web is then slit to form the plurality of adjacent equal width strips for fabrication of the hollow core element.

In accordance with the hollow core lay-up method of my above identified application, flutes are formed in the fluted web 15 of a substantially larger size than typically used for corrugated paperboard. The flutes may have a height of about ½ in. and, in order to provide a stack of strips 14 to make a module 11 with an 8 ft. width, approximately 180 to 200 strips would be required. The strips are 16 in. wide and 50 ft. long. The method and apparatus of my above identified application are capable of forming up hollow core elements of the required size.

Each of the rectangular hollow core elements 13 has plan dimensions of 8 ft.×50 ft. Steel sheets comprising an upper skin 17 and a lower skin 18 are attached to the respective upper and lower surfaces 20 and 21 of the hollow core element 13. The upper skin 17 may be, for example, ⅛ in. in thickness and the lower skin 18 may be ¼ in. in thickness. Although high modulus steel is preferred, other materials may be utilized, particularly for the upper skin where tensile strength and high modulus of elasticity are not major concerns. The skins 17 and 18 may be secured to the hollow core element 13 with any of a number of suitable adhesives, including epoxies. The resulting deck module 11 is attached to like modules to fabricate the deck 10 shown in FIG. 1. Modules 11 are positioned side-by-side, preferably in their final positions in the structure in which they are used, with the long edges 22 of the steel skins 17 and 18 abutting. In this position, each abutting pair of upper skins 17 and lower skins 18 are connected with welds 23.

The upper surface of the upper skins 17 are provided with an array of upstanding projections 24, preferably short steel posts 25 which are welded to the skin 17. The height of the posts 25 depends on the thickness of the concrete slab 12, but for a 4 in. slab, posts having a height of about 3 in. are satisfactory. Once the modules 11 are welded together, concrete is poured onto the upper skin surfaces to form a slab 12 of a desired thickness. Any necessary utility connections, such as electric power conduits, piping and the like are placed on the upper skin surface and embedded in the subsequently poured concrete.

The exposed core elements 13, along the outer periphery of the fabricated deck 10, are closed with suitable close-out panels 26. The panels 26 may be made of any suitable material and glued, welded or otherwise secured to the exposed core elements 13 or the edges of the skins 17 and 18.

Although the composite structural support of the present invention has been described with respect to the fabrication of a floor for a building or a deck for a bridge, the present invention lends itself well to the fabrication of structural supports of a wide variety of shapes and sizes. For example, a much narrower module, namely one using a much smaller number of strips 14 (say 16 strips stacked to form a hollow core element about 8 in. wide) can function as a beam.

A floor, deck or beam member made in accordance with the present invention could be provided with a camber as is sometimes done in long span beams. The inherent flexibility of the fluted paper core element 13 will permit the necessary flexure to be imparted to provide a camber. For example, one of the skins 17 or 18 could be applied to the core element, the element then flexed to the desired camber and the other skin attached to the core in the bowed orientation.

I claim:

1. A method for making a load bearing deck comprising the steps of:
(1) forming single face web comprising a liner web and a fluted web;
(2) orienting the single face web with the exposed fluted web flutes facing up;
(3) slitting the single face web longitudinally to form a plurality of adjacent equal width single facer strips;
(4) gluing the exposed flute tips of each single face strip to the smooth web of a next adjacent strip to form an open core element with the flutes extending between and perpendicular to parallel opposite core element faces;
(5) bonding rectangular steel skin sheets to the opposite faces of the core element to form a deck module; and,
(6) connecting adjacent modules by welding adjacent upper and lower skin edges along abutting long edges of the skin sheets.

2. The method as set forth in claim 1 including the step of pouring a layer of concrete over the interconnected upper skin sheets.

3. The method as set forth in claim 2 including, prior to the pouring step, the step of attaching a plurality of upstanding steel projections to the exposed surfaces of the upper skin sheets, and wherein the pouring step includes embedding said projections in the concrete.

4. The method as set forth in claim 2 including, prior to the pouring step, the step of placing utility connections on the exposed surface of the upper skin sheets, and wherein the pouring step includes embedding said connections in the concrete.

5. The method as set forth in claim 1 including the step of flexing the core element to provide a camber.

6. The method as set forth in claim 5 including the steps of:
(1) attaching one of the skin sheets prior to the flexing; and,
(2) attaching the other skin sheet after flexing.

7. A method for making a load bearing deck comprising the steps of:
(1) forming an open face double wall web comprising two single face webs joined to define an exposed liner web and an exposed fluted web;
(2) orienting the single face web with the exposed fluted web flutes facing up;
(3) slitting the open face double wall web longitudinally to form a plurality of adjacent equal width open face double wall strips;
(4) gluing the exposed flute tips of each open face double wall strip to the smooth web of a next adjacent strip to form an open core element with the flutes extending between and perpendicular to parallel opposite core element faces;
(5) bonding rectangular steel skin sheets to the opposite faces of the core element to form a deck modular; and,
(6) connecting adjacent modules by welding adjacent upper and lower skin edges along abutting long edges of the skin sheets.

8. The method as set forth in claim 7 wherein the hollow core elements are formed from paper webs.

9. The method as set forth in claim 8 wherein the paper webs are impregnated with a resin.
